(19) United States
(12) Patent Application Publication
(10) Pub. No.: US 2014/0164954 A1
(43) Pub. Date: Jun. 12, 2014

(54) Rating Viewable Events

(71) Applicant: Timothy Romanowski, Corvallis, OR (US)

(72) Inventor: Timothy Romanowski, Corvallis, OR (US)

(21) Appl. No.: 13/712,484

(22) Filed: Dec. 12, 2012

(51) Int. Cl. G06F 3/048

(52) U.S. Cl. CPC G06F 3/048
USPC 715/753

(57) ABSTRACT

Embodiments are disclosed to provide the rating of viewable events. Rating viewable events will allow users to know whether a venue, such as a restaurant, bar, or private home, is a satisfactory place to view their favorite teams. Information about venues and events is populated in a database by a plurality of venues or users. Users wishing to view a particular event can search for a venue that has a high venue rating. Users may also vote whether a venue was satisfactory and the results of the vote may be used to generate future ratings.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

The present invention relates to a method for determining venue-specific event participation, and more specifically, to rating viewable events and making the ratings available in a publicly accessible database.

2. Description of the Related Art

It is well known within the related art that crowdsourcing is hugely successful in problem-solving tasks. Much like scientific research committees or focus groups, crowdsourcing is an activity in which an individual, an institution, a non-profit organization, or company proposes to a group of individuals of varying knowledge, heterogeneity, and number, via a flexible open call, the voluntary undertaking of a task.

The undertaking of the task, of variable complexity and modularity, and in which the crowd should participate bringing their work, money, knowledge and/or experience, always entails mutual benefit. The user will receive the satisfaction of a given type of need, be it economic, social recognition, self-esteem, or the development of individual skills, while the crowdsourcer will obtain and utilize to their advantage that what the user has brought to the venture, whose form will depend on the type of activity undertaken.

Within the related art, the advent of the Internet enhanced the ease at which crowdsourcing could be performed, and became a preferred method for distributing tasks or calling upon voluntary user input for completing said tasks. Crowdsourcing has revolutionized how music reaches listeners by enabling Pandora Internet Radio enthusiasts to collaboratively group and categorize music into genres and like-artist specific channels. The Galaxy Zoo Project has allowed amateur astrologists to classify over 50 million galaxies photographed in the Sloan Digital Sky Survey. The Internet encyclopedia, Wikipedia, relies predominantly on non-profit crowdsourcing to create, update, and maintain over 23 million pages of information.

Further enhancing distribution and collection of data, mobile devices allowed figures and data to be submitted from virtually anywhere a signal could be had. These devices untethered users from their home computers and allowed for situational, and location-based inputs. Those being crowdsourced could report, without any delay, to the crowdsourcer, and as such, accuracy increased dramatically. As a side effect of this promptness, the type of distribution-based problems could evolve towards those based on real-time, present scenarios.

At present, implicit crowdsourcing and explicit crowdsourcing provide two separate avenues of obtaining and using sourced information. As a result of the increasing speeds at which data can be obtained, it could be said that this results in a need of an intermediate between the two whereas a user can input their own evaluations of an entity, while simultaneously, a database is implemented and immediately modified to alter a proposed output based upon the initial users input.

The immediate input, output, and retrieval of data to mobile devices is not a new to the art. Weather applications use input from mobile users and stations to establish current, accurate, location-based weather conditions that are easily accessed via mobile applications. Many car enthusiasts use mobile applications to report and compile known locations of traffic enforcement officers or speed traps.

Crowdsourcing can also be used in the acquisition of data to be used in the rating of certain events. Users submit satisfaction scores to a readily accessible database based upon their experiences with the subject in question.

Apple Inc. employs a ratings system within iTunes which uses input from other iTunes users to broadcast their overall satisfaction with a particular piece of media based upon their own experience. This makes it possible for future users to identify whether or not their own satisfaction will be met by the previously rated media. Netflix uses a similar method for applying a rating system, and additionally, takes the user's own ratings and genre preferences into consideration when recommending viewable media to the end user. Without an accessible ratings system implemented, an individual must rely on chance, not knowledge, for a pleasant experience.

This rating method can be useful to an individual searching for the best possible venue to view a specific sporting event. Unfortunately, within the related art, there exists no method which allows the end user to obtain sports-team-specific satisfaction ratings within a plurality possible viewing venues. The present invention meets this need by establishing a method for obtaining team-specific user satisfaction ratings of all possible venues and making them available to other users.

### BRIEF SUMMARY OF THE INVENTION

Embodiments are disclosed to provide the rating of viewable events. Rating viewable events can be used to determine whether a viewer will be satisfied when viewing an event at a particular venue, such as a restaurant, bar, or private home. Users wishing to find a venue that is likely to provide a satisfactory viewing experience will be able to see customized ratings and the individual ratings that comprise the customized ratings. The customized ratings inform the viewer of whether they will be satisfied when watching an event at a particular venue.

In a preferred embodiment of the present invention, a viewer could create a profile containing a list of his or her favorite sports teams. The viewer could then respond to questions asking whether a particular venue is a good place to watch the teams listed in their profile. A viewer may answer the questions by providing a yes or no response for each question. The venue may then be given a satisfaction rating which is the percentage of yes or no votes for each team in the viewer's profile. A customized venue rating may then be calculated by taking the average rating, by team, for a venue from users submitting votes. Viewers may then view the customized venue rating when deciding which venue to attend to view a team.

In another preferred embodiment of the present invention, a user may launch a mobile application on a portable computing device. The mobile application may communicate with a database that allows the user to enter venue or viewable event information. The user may enter a vote for whether a venue is a good place to watch a viewable event. A customized rating for a venue may be generated that indicates if the venue is a satisfactory location to view an upcoming viewable event. The customized rating may then be displayed to other users via the mobile application. Other users may use the customized rating to decide whether to attend a venue to view an upcoming viewable event.

The preceding embodiments are intended to be exemplary in nature and are not intended to be limiting. It is possible that those skilled in the art will see further embodiments of the present invention. Other objects and advantages of the present invention will be more fully apparent from the following disclosure.

### BRIEF DESCRIPTION OF THE SEVERAL VIEWS OF THE DRAWING(S)

FIG. 1 is a flowchart for rating viewable events as according to one embodiment of the present invention;

FIG. 2 is a flowchart for selecting a venue to view a viewable event using rating information as according to one embodiment of the present invention;

FIG. 3 is a schematic block diagram of a user and ratings engine relationship for rating viewable events as according to one embodiment of the present invention;

FIG. 4 is an exemplary window of a mobile application with a rating feature for rating viewable events as according to one embodiment of the present invention; and

FIG. 5 is a schematic diagram of an exemplary viewable event rating system as according to one embodiment of the present invention.

A further understanding of the present invention can be obtained by reference to preferred embodiments set forth in the illustrations of the accompanying drawings. Although the illustrated embodiments are merely exemplary for carrying out the present invention, both the organization and methods of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

### DETAILED DESCRIPTION OF THE INVENTION

In the following detailed description, reference is made to the accompanying drawings that show, by way of illustration, specific embodiments in which the invention may be practiced.

These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

In a manner described below, the data processing aspects of the present invention may be implemented, in part, by programs that are executed by a computer. The term “computer” as used herein includes any device that electronically executes one or more programs, such as personal computers (PCs), hand-held devices, multi-processor systems, microprocessor-based programmable consumer electronics, network PCs, minicomputers, mainframe computers, routers, gateways, hubs and the like. The term “program” as used herein includes applications, routines, objects, components, data structures and the like that perform particular tasks or implement particular abstract data types. The term “program” as used herein further may connote a single program application or module or multiple applications or program modules acting in concert. The data processing aspects of the invention also may be employed in distributed computing environments, where tasks are performed by remote processing devices that are linked through a communications network. In a distributed computing environment, programs may be located in both local and remote memory storage devices.

Referring now to the present invention, there is described exemplary embodiments for rating viewable events. For the purpose of clarity, the terms “rating viewable events”, “rating events”, “present invention”, and “invention” may be used interchangeably to refer to the afore-mentioned rating viewable events invention.

Several preferred embodiments for rating viewable events are discussed in this section. However, the invention is not limited to these embodiments. The present invention includes any form of rating venues for purposes of assisting users with determining which venue to attend to view an event. The rating techniques are not limited in terms of number or type of venues or users, information used to generate the rating, communication method, event type, or venue.

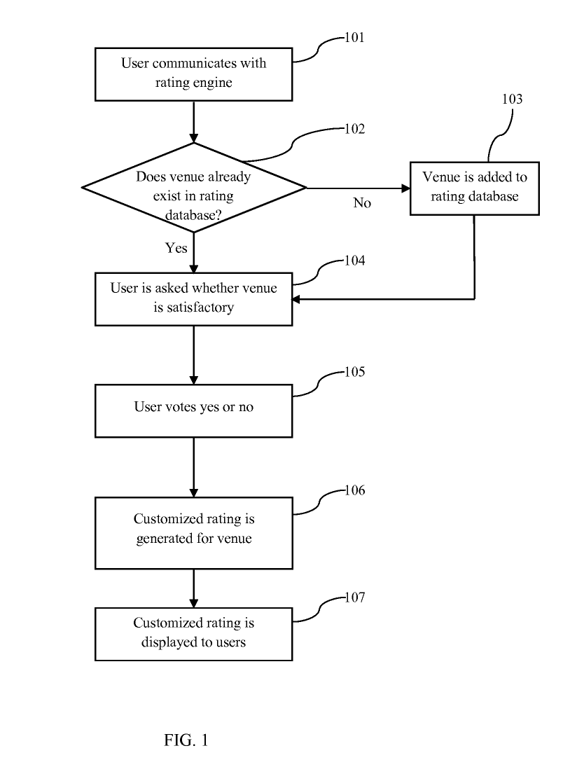

Referring now to FIG. 1, there is shown a flowchart for rating viewable events as according to one embodiment of the present invention. A user may communicate with a ratings engine (101) to input or retrieve ratings for a venue. The ratings may be a satisfaction indicator that lets a user know whether they will be satisfied if they attend a venue to see a particular team play. This satisfaction type of rating could be generated by simply asking a user whether he or she believes the venue is a good place to watch a game. Part of the novelty of this invention is the subjective criteria by which a user must make the “good or not” decision. Independent evaluation standards may be developed by each user that could yield a more accurate rating for a venue showing a particular team. Whether a venue is considered a good place to watch a game or not may depend on a number of subjective criteria that could vary from user to user. For example, one user may decide a venue is good or not based on comfort factors such as the quality of the food served while watching a team, the comfort of the chairs the user sat in, or the ambient noise in the venue while a game was displayed. Other users may decide that a venue is good or not based on the physical characteristics of the venue such as the size of the television used to display a game, the number of available seats, or the hours and location of the venue.

If the venue does not exist in the database (102), the user may create a for the venue (103). Adding the venue to the database (103) may include, but not be limited to adding information about the venue such as address, hours of operation, number of viewing devices, how many viewable events the venue can display, whether the venue requires users to pay to view the event, whether the venue has the proper subscriptions to display the event, how many times the venue has displayed similar events, menu selections, type of establishment, or any other information requested by a viewable events ratings engine. If information about the venue is already in the database (102), or the user has added venue information to the database (103), the user may be asked whether the venue was a good place to watch a viewable event or a particular team (104). Viewable events may include a sporting event, a news event, or an entertainment event. In one preferred embodiment of the present invention, a user could be asked whether a venue is a good place to watch his or her favorite football team (104). In another preferred embodiment of the present invention, a user could be asked whether a venue is a good place to watch his or her favorite professional golfer (104). The user could also be asked whether the venue is a good place to watch other teams in his or her profile.

A user may vote yes or no (105) when asked whether the venue was a good place to watch a team. A customized rating could be generated for a venue (106) based on one or more individual user vote results (105). The customized rating may be calculated (106) by taking the average number of yes votes from the total number of votes. Individual customized venue results could be displayed to users (107) for each team in their profile. These individual customized results could be generated (106) by returning the average team yes ratings for a venue for every team in the user's profile. A venue's overall satisfaction rating for a particular user could be generated by calculating the aggregate number of yes votes from the total number of votes for every team in a user's profile. This would allow a user to see whether a venue would be a good place to watch any of the teams in their profile. The ratings engine may use the yes or no vote information stored in the rating database to generate the rating (106).

The rating of viewable events steps presented in FIG. 1 may be performed by way of an application or a computer program. A cell phone, tablet computing device, laptop, or desktop, or any combination thereof may be used when executing the application or program.

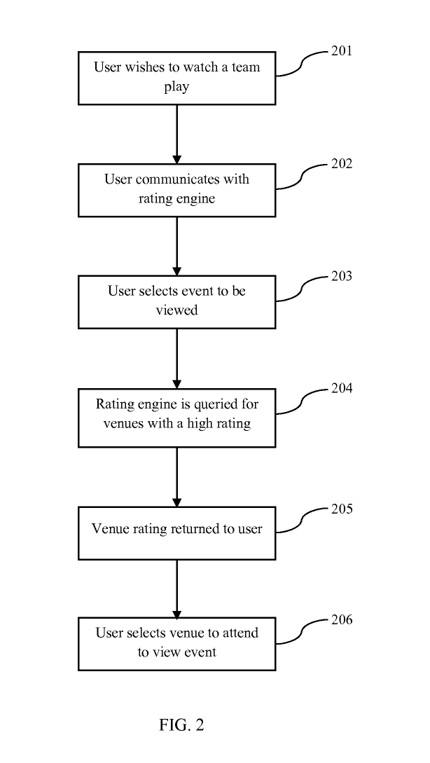

Referring now to FIG. 2, there is shown a flowchart for selecting a venue to view a viewable event using rating information as according to one embodiment of the present invention. A user may wish to watch a team play in a sporting event (201). The user may communicate with a ratings engine (202) to locate a venue that has a high rating for that team. Communication with the ratings engine may occur by using an application on a mobile device such as a cell-phone or tablet computer, or by using a web browser to access an Internet site on a desktop, laptop, or other computing device. When communicating with the ratings engine (202), the user may select an event to be viewed (203). The event may be a game in which the user's team is playing. The ratings engine may be queried for venues that have been given a high rating (204). A high rating may be considered a large percentage of yes votes when users were asked if the venue was a good place to watch an event. The ratings may also consist of events in which the team that the present user wishes to view participated. After querying the ratings engine (204), venue ratings may be returned to the user (205). The user may evaluate the returned ratings and select the venue to attend to view the upcoming event (206).

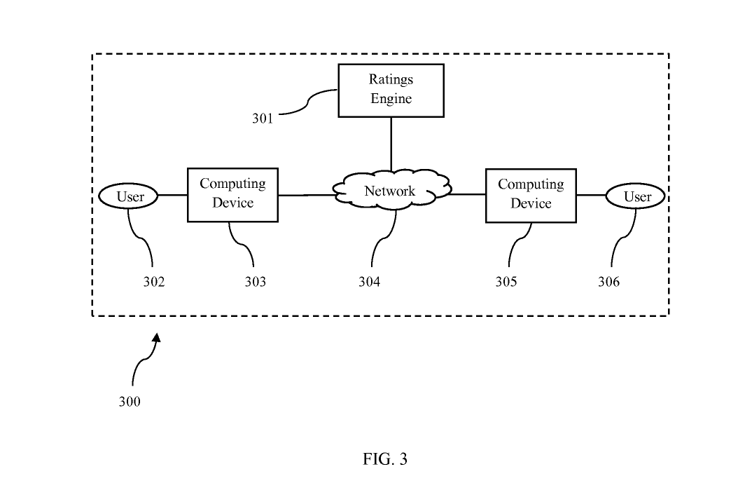

Referring now to FIG. 3, there is shown a schematic block diagram of a user and ratings engine relationship for rating viewable events (300) as according to one embodiment of the present invention. A user (302) may use a computing device (303) to communicate through a network (304) with a ratings engine (301). The user (302) may communicate with the ratings engine (301) for the purposes of uploading yes or no votes that indicate whether a venue was a good place to watch an event, or for the purposes of retrieving venue ratings so that the user may decide where to a team play. A second user (306) may use a second computing device (305) to communicate through a network (304) with a ratings engine (301). The second user (306) may communicate with the ratings engine (301) for the similar purposes of uploading yes or no votes and retrieving venue ratings. Both users (302, 306) may also communicate with the ratings engine (301) to obtain venue information such as location, address, hours of operation, menus, or any other venue information that the ratings engine may possess. It should be noted that the users (302, 306) may communicate with the ratings engine (301) to perform any of the steps set forth in FIGS. 1 and 2.

The computing devices (303, 305) may include any computational device such as laptops, palm devices, desktops, mobile devices, cellular telephones, tablets, smartphones, media storage devices, or any other device capable of performing rating functions. The computing devices (303, 305) may connect to a network (304) by way of wireless or wired communications. Wireless communications may include WiFi, cellular communications, or any other wireless communication protocols. The computing devices (303, 305) may access the ratings engine (301) through the network (304) in order to transmit or receive information. The ratings engine (301) may include a database that is a computer-implemented repository that contains venue information, viewable event information, rating information, or user information. Users (302, 306) may access information from the ratings engine (301) or retrieve information from the ratings engine (301) in order to retrieve venue ratings; to upload venue (302), viewable event or user (306) information; or to retrieve venue (302) or viewable event information. Viewable event information may include what time the event will occur, the participants in the event, the location of the event, the type of event, the score of the event, or any other type of information relating to the event. User information may include such information as check-ins, and the events that users (302, 306) viewed at a venue.

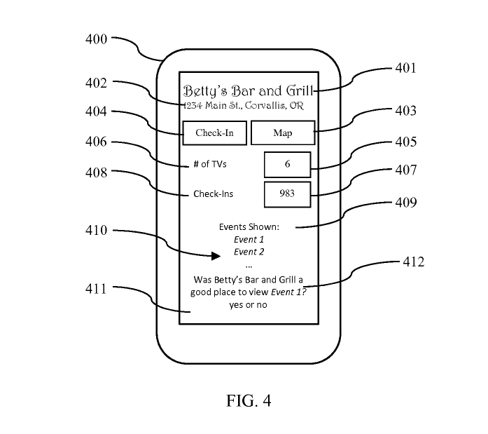

Referring now to FIG. 4, there is shown is an exemplary window of a mobile application (411) with a rating feature (412) for rating viewable events as according to one embodiment of the present invention. The window (411) may be contained within an application developed for rating viewable events. A portable device such as a smartphone or tablet (400) may be used to execute the application. The window (411) may contain features that allow a user to rate whether a venue is a good place to view an event (412). The features may include the name of a venue (401), the address of a venue (402), a check-in button (404) for checking-in at a particular venue, a map access button (403) that may retrieve a map showing the location of the venue, a number of TVs field (406) that displays the number of televisions (405) at the venue, a check-in field (408) that displays the number of check-ins (407) at a venue, and a viewable events field (409) that lists one or more viewable events (410) being shown at the venue. A user may access the window (411) within the application when the user wishes to vote whether a venue was a good place to watch an event, or when the user wishes to retrieve information indicating whether the venue was a good place to watch an event.

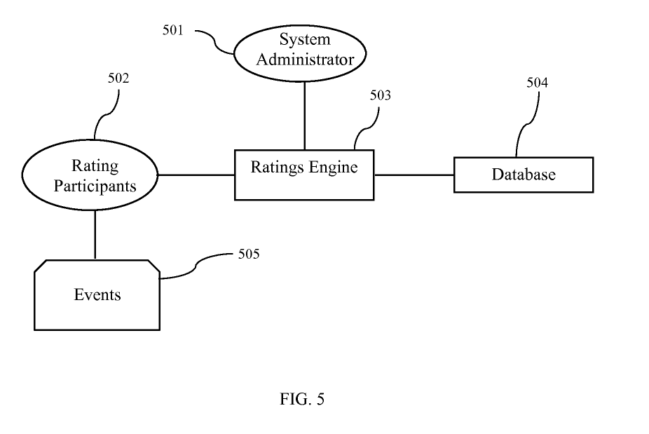

Referring now to FIG. 5, there is shown a schematic diagram of an exemplary viewable event rating system as according to one embodiment of the present invention. The viewable event rating system may include a system administrator (501) that could maintain system integrity, manage the viewable event rating system, set permissions, add or remove information from the system, or perform any other function of a system administrator. Viewable event rating participants (502) may be users that participate in the viewable event rating system by sending or receiving information to or from a database (504) that is controlled by a ratings engine (503). The information may include, but not be limited to, whether the venue is a good place to watch an event or a team, adding information about the venue such as address, hours of operation, number of viewing devices, how many viewable events the venue can display, whether the venue requires users to pay to view the event, whether the venue has the proper subscriptions to display the event, how many times the venue has displayed similar events, menu selections, type of establishment, or any other information requested by a viewable events ratings engine (503). The information may also include information about a viewable event (505) such as whether it is a sporting event, a news event, an entertainment event; the teams or participants in the event; the duration of the event; a rating for the event; or any other information requested by a ratings engine (503). The information may be used by the viewable event rating participants (502) to let other viewable event rating participants (502) know whether a venue will display a viewable event (505), or to find venues with a high probability of displaying a desired viewable event (505). The ratings engine (503) may contain the logic that operates the viewable event rating system. One logic component may assimilate information from the viewable event rating participants (502) and associate venues with viewable events (505). Another logic component may be a gateway that controls information received from, or transmitted to, viewable event rating participants (502). Yet another logic component may generate a viewable event satisfaction indicator from a plurality of information in the database (504).

It should be noted that the example software and/or firmware implementations described herein may be optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of this disclosure are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain exemplary embodiments for rating viewable events have been described herein, the scope of coverage of this patent is not limited thereto. On the contrary, this patent covers all embodiments for rating viewable events fairly falling within the scope of the invention either literally or under the doctrine of equivalents.

With respect to the above description then, it is to be realized that the optimum configuration and relationships for the elements for rating viewable events are deemed readily apparent and obvious to one skilled in the art, and all equivalent relationships to those illustrated in the images and described in the specification are intended to be encompassed by the present invention.

Therefore, the foregoing is considered as illustrative only of the principles for rating viewable events. Further, since numerous modifications and changes will readily occur to those skilled in the art, it is not desired to limit the center to the exact construction and operation shown and described, and accordingly, all suitable modifications and equivalents may be resorted to, falling within the scope for rating viewable events. While the above description describes various embodiments of the present invention, it will be clear that the present invention may be otherwise easily adapted to satisfy any requirements for rating viewable events.

As various changes could be made in the above configuration or organization without departing from the scope of the invention, it is intended that all matter contained in the above description or shown in the accompanying images shall be interpreted as illustrative and not in a limiting sense.

What is claimed is:

1. A method comprising:
receiving votes from one or more users, wherein the votes are user responses when asked whether a venue is a good place to watch a team or a viewable event; using a ratings engine to generate a rating that indicates whether the venue is a good place to view the team or viewable event; generating the rating by calculating the percentage of favorable votes received from the users; and providing the rating to one or more users.

2. The method of claim 1, wherein the votes are yes or no responses.

3. The method of claim 2, wherein the yes or no responses are responses from users when asked if a venue is a good place to view the team or viewable event.

4. The method of claim 1, wherein the rating is provided to one or more users so that the one or more users may decide where to view an event or team.

5. The method of claim 1, wherein the percentage of favorable votes is the percentage of yes votes out of the total number of votes.

6. The method of claim 1, further comprising generating the rating for every team in a user's profile.

7. The method of claim 6, wherein the user's profile comprises a list of teams entered by the user.

8. The method of claim 1, wherein a mobile application is to communicate with the ratings engine.

9. A system for rating viewable events comprising:
a ratings engine that generates a rating that indicates whether a venue will be a good place to view an event, one or more databases configured to store information about a plurality of venues and a plurality of viewable events, and an application that allows a user to retrieve the rating from the ratings engine so that the user may determine which venue to attend to view a viewable event.

10. The system of claim 9, wherein the viewable events are sporting events.

11. The system of claim 9, wherein the information about a plurality of viewable events includes the teams participating in the viewable events.

12. The system of claim 9, wherein the information about a plurality of venues includes the name of the venue.

13. The system of claim 9, wherein the application is executed on a computing device.

14. The system of claim 9, wherein the information in the one or more databases is provided by one or more users.

15. A method for rating viewable events comprising:
receiving viewable event information, receiving user information, generating a rating that indicates whether a venue will be a good place to view an event, transmitting the rating to a user.

16. The method of claim 15, wherein the viewable event information includes the teams participating in the events.

17. The method of claim 15, wherein the venue information includes the name of the venue.

18. The method of claim 15, wherein the rating is generated by calculating the percentage of yes votes from the total number of votes.

19. The method of claim 15, wherein the viewable event information and the user information is stored in one or more databases.

20. The method of claim 15, wherein the user uses a computer application to receive the rating.
